(19) United States
(12) Patent Application Publication
(10) Pub. No.: US 2010/0233408 A1
(43) Pub. Date: Sep. 16, 2010

(54) WEATHERPROOF UNDERLAYMENT WITH HIGH FILLER CONTENT POLYMER ASPHALT LAYER

(75) Inventors: Thomas Zickell, New Castle, NH (US); James Karlis, Pelham, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Northern Elastomeric, Inc., Brentwood, NH (US)

(21) Appl. No.: 12/731,706

(22) Filed: Mar. 25, 2010

Related U.S. Application Data
(63) Continuation of application No. 11/291,634, filed on Dec. 1, 2005, now abandoned.

(51) Int. Cl. E04D 5/10; B32B 11/02

(52) U.S. Cl. 428/40.3; 428/354

(57) ABSTRACT

A roofing membrane underlayment material includes a fibrous mat generally encapsulated within a non-adhesive asphalt coating, the resulting encapsulated mat having an adhesive asphalt layer applied to one surface thereof, typically the bottom surface. An acrylic, talc or granular coating is applied to the surface of the encapsulated mat that is not in contact with the adhesive asphalt layer. The non-adhesive asphalt coating is characterized in that it includes a high filler content made possible by the use of non-oxidized flux asphalt to which has been added a small percentage of an asphalt additive such as radial or linear polymer or other elastomer. The resulting membrane, when applied to a roofing deck, provides a high traction surface that will not adhere to shingles and provides an effective waterproofing seal on the roofing deck and is flexible in both hot and cold environments.

### RELATED APPLICATION

This application is a Continuation-in-part of U.S. patent application Ser. No. 11/291,634 filed on Dec. 1, 2005, entitled “Weatherproof Underlayment With High Filler Content Polymer Asphalt Layer” and fully incorporated herein by reference.

### TECHNICAL FIELD

The present invention relates to roofing and other similar underlayments and more particularly, to underlayments having a fibrous mat having at least a top surface coated with an asphalt layer including flux or non-oxidized asphalt, a copolymer and a high filler content.

### BACKGROUND INFORMATION

Asphalt based roofing shingles are presently installed on approximately eighty percent of the homes in the United States. In areas where snow accumulates, roof shingles can develop leaks as a result of ice dams, which can form along the eaves of a roof. Ice dams form as the result of a differential temperature, which occurs between the eaves of the roof and the interior sections of the roof. The temperature differential occurs when heat rises into the attic space. Under certain temperature conditions, snow collected on the roof surface will melt along the upper interior portions of the roof and then freeze when the liquid snow-melt reaches the cooler eave section of the roof. As can be seen in FIG. 1, the result is that a pool 1 of liquid water can form between the roof surface 2 and the ice dam 3. The ice dam 3 prevents the water from reaching the gutter 4 and draining away. Ultimately, the liquid water 1 can leak 5 through the roof surface 2, causing interior water damage to the structure. Ice dams can also occur as a result of frozen slush accumulating in gutters, also causing liquid to collect and leak through the roof.

In a typical roofing installation using asphalt shingles, an underlayment is first applied to the plywood deck of the roof. The underlayment may take the form of an asphalt saturated paper which is useful as a waterproofing member. Roofing shingles are applied on top of the underlayment with the seams of adjacent rows positioned in an offset relationship. In practice, a starter row or strip is begun at the roof eaves using self-sealing shingles. The end of the first shingle in the strip is trimmed such that, when it is placed on the deck, the cutouts of the first course of shingles will not be placed over the starter strip joints. The starter strip and the shingles are nailed to the eaves. Successive rows of shingles are then secured to the deck or roof using nails.

To ensure maximum protection against ice dams, membranes or metal flashing is installed wherever there is a possibility of icing, such as along the eaves of the roof. As noted above, ice dams are formed by the continual thawing and freezing of melting snow, or the backing up of frozen slush in gutters, which force water under the roofing, thereby causing damage to a structure's ceilings, walls, and insulation. The ice damming problem is most acute on low-slope roofs; that is, roofs with a slope of two inches (5.08 cm) to four inches (10.16 cm) per foot (30.48 cm).

Traditional eaves flashing has either been 50-pound coated felt or two layers of 15-pound saturated felt cemented together. The term “pound” is defined as the weight of the felt required to cover an area of 108 square feet. Typically, the asphalt used in the fifty-pound felt is not modified with rubber, and after aging, will not form a good seal around nails. Additionally, the installation of two layers of 15-pound saturated felt consumes undesirable amounts of time and also will not seal around nails.

The use of self-adhesive products, such as ice and water protective membranes, has now become commonplace. One example of such a product is described in the U.S. Pat. No. 6,531,200 which is assigned to the assignee of the present invention and incorporated fully herein by reference as well as its parent application, U.S. Pat. No. 6,292,212. Although this and similar products have been quite successful, the oxidized asphalt layer which is used to impregnate the fibrous mat on the upper surface of the underlayment, and which serves to allow the top surface of the underlayment to be walked upon and not stick to the roofing material, makes the finished product quite brittle. This problem is particularly acute in Northern or other cold weather regions. Finally, an additional problem is the rising cost of asphalt, which has considerably driven up the price to manufacture such a product.

Accordingly, a need exists to produce a self-adhesive waterproof underlayment which includes a top layer of oxidized asphalt which can be walked upon by the installers, to which roofing shingles will not stick and which is relatively bendable in cold weather. In addition, a need also exists to reduce the amount of asphalt required to manufacture such a product by adding a high amount of filler material and thereby reduce the cost of the finished product while at the same time insuring that the quality, functionality and characteristics of the finished product are essentially unchanged.

### SUMMARY

The present invention relates to roofing membrane materials having a fibrous mat surface, which provides traction, structural integrity and lap sealing capabilities. More particularly, the present invention relates to a roofing membrane material having an adhesive surface provided by an adhesive rubberized asphalt layer and non-adhesive surface provided by a woven or non-woven fibrous mat encapsulated within a non-adhesive asphalt coating. The adhesive rubberized asphalt layer is very adherent and provides excellent adhesion of the membrane to a roof deck, while the encapsulated fibrous mat provides a surface having excellent traction and lap sealing characteristics. A coating or an internal incorporation of material such as a polyethylene or other polymers, waxes or the like that adhere to the asphalt and provide a non-slip surface may also be coated onto the non-adhesive top surface to enhance its non-adhesive characteristics and provide traction and flexibility.

In the preferred embodiment, traction is further enhanced by providing granules of a particulate material embedded in the non-adhesive top surface. The coating of the top surface prevents shingles from adhering to the membrane, while the elastomer, polymer or plasticizer makes the construction of the top layer flexible in low temperatures. The preferred material for forming the fibrous mat is fiberglass, polypropylene or polyester.

For preventing multiple layers of the membrane from adhering to one another during shipping and storage, a release sheet can be applied to the lower, adherent surface of the rubberized asphalt layer. As a result of the release sheet, when the membrane is rolled, or when several layers of the membrane are stacked together, the release sheet is interposed between the sticky lower surface of the rubberized asphalt and the adjacent traction layer. By interposing the release sheet, adhesion between subsequent layers of the membrane material is prevented. During application to a roof surface, the release sheet is removed, thereby allowing the sticky underside of the membrane to adhere to the roof.

One object of the present invention is to provide a rubberized asphalt roofing product which can be applied along the eaves of a roof to serve as a water infiltration barrier for the overlying shingles and which is flexible in both hot and cold weather and performs well in both hot and cold weather.

Another object of the present invention is to provide a roofing membrane having a non-slip surface for the safety of roof installers.

A further object of the invention is to provide a roofing membrane that will not adhere to shingles, thereby allowing the shingles to be easily removed and replaced, if necessary.

Yet another object of the invention is to reduce the cost of the manufactured product by reducing the amount of asphalt needed in the product by means of introducing a high amount of filler in the oxidized asphalt coating.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a side elevational view of a portion of a roof showing an ice dam;

FIG. 2 is a sectional view of the roofing membrane of the present invention;

FIG. 3 is a schematic representation of one process for manufacturing the roofing membrane of the present invention;

FIG. 4 is a perspective view of the eaves of a roof having the membrane of the present invention, and several shingles, applied thereto; and

FIG. 5 is a side elevational view of the portion of the roof shown in FIG. 4, with the shingles removed for the purpose of clarity.

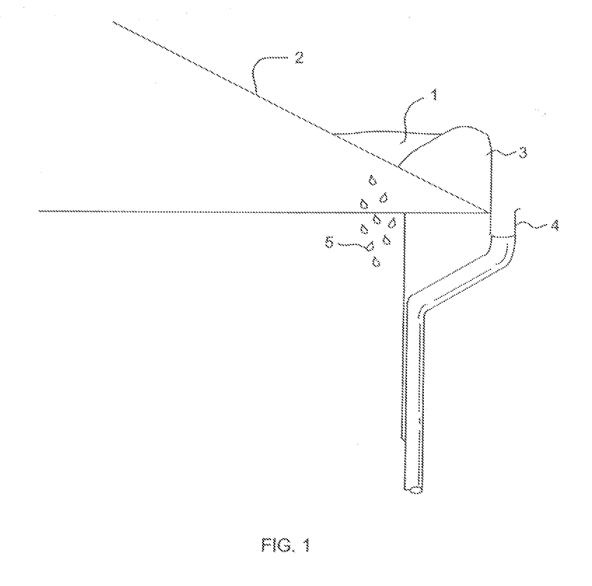

### DETAILED DESCRIPTION OF THE PREFERRED EMBODIMENTS

The present invention relates to self-adhesive membranes that have been developed to eliminate problems associated with ice dams and the like. The inventive membranes have a woven or non-woven fibrous mat, which is encapsulated within a relatively non-adhesive asphalt composition. One surface of the coated mat is provided with an acrylic coating that optionally contains finely ground particles of talc or other mineral materials. The other surface of the encapsulated mat supports a rubberized asphalt layer that adheres directly to the wood deck of a roof or other substrate. Roof shingles may then be applied directly over the membrane. The membrane prevents water entry into the structure by adhering to the deck and sealing around the nails that are used to hold the shingles to the roof deck. However, since the membrane has been provided with a relatively non-adhesive asphalt upon which is coated an acrylic material, shingles placed against the membrane do not adhere to it, either upon placement or after an extended period of time.

In a broad sense, the present invention comprises a roofing membrane material having a traction layer formed by a fibrous mat which is generally fully saturated with a relatively non-adhesive asphalt, which asphalt extends generally to the top surface of the mat. The mat further includes, on the bottom surface, an adhesive asphalt coating such as that described below.

The relatively non-adhesive asphalt material on the top surface, in the preferred embodiment, comprises a mixture of an oxidized asphalt, a flux asphalt, an elastomer (sometimes referred to as a polymer or polyolefin) (such as radial or linear SBS rubber, or polyethylene) and fillers such as talc and limestone. These components may be present over a wide compositional range, but a ratio of approximately 2% radial SBS polymer (such as styrene-butadiene copolymer or styrene-butadiene-styrene copolymer), 50% filler, 24% flux asphalt and approximately 24% oxidized asphalt is preferred although various ranges of the various ingredients is contemplated by and within the scope of the present invention. The inclusion of the oxidized asphalt is desirable in that it is relatively inexpensive, has excellent high temperature stability due to its Ring and Ball melt point of about 225-250 degree F. (about 107-121 degree C.), helps to create a non-stick, but safe walking surface and most importantly, by using with polymer creates a less brittle product especially for cold weather climates while also insuring flexibility in hot weather without the asphalt softening so much that the surface becomes too sticky or will give way underfoot.

Using a method that will be described in detail below, the relatively non-adhesive asphaltic layer is applied to the fibrous mat in a manner such that it infiltrates generally completely through the mat's thickness while an adhesive asphalt layer is provided on the other or intended bottom surface of the encapsulated mat.

The fibrous mat may be any of a wide variety of woven or non-woven materials. In one preferred embodiment, the fibrous mat comprises a non-woven fiberglass mat. In another preferred embodiment, the fibrous mat comprises a non-woven polyester or polypropylene mat. The mat is preferably saturated at least proximate the top surface with a generally non-adhesive material which comprises between 0.5% to 5% polymer additive, such as radial SBS rubber or linear SBS rubber; 15% to 65% filler; 5% to 60% of flux asphalt and between 10% to 80% oxidized asphalt, and then coated with fine mineral granules (such as talc or sand). The polymer additive can be added as a liquid or an undissolved solid to be mechanically dispersed during the mixing process. An example of this would be ground tire rubber.

In another preferred embodiment, the fibrous mat is preferably saturated, at least proximate the top surface of the mat, with a generally non-adhesive material that comprises between 20% to 95% asphalt. The asphalt may be oxidized or non-oxidized asphalt or a combination of the two types. In addition, the asphalt mixture may contain 0.5% to 30% polymer, 0.5% to 30% organic filler, 0% to 20% process oil and 5% to 60% inorganic mineral filler. The polymer is a thermoplastic polymer having a melting point range between 200-500° F. (about 93-260 degree C.). The thermoplastic polymer may be polyethylene, polypropylene or TPO. The organic filler may be a polymer with a melting point about 500° F. (about 260 degree C.) or a cross-linked or thermoset polymer. The process oil may be an asphalt compatible oil, such as an aromatic or paraffinic hydrocarbon oil. The inorganic mineral filler may be talc, calcium or carbonate.

The asphalt coating tends to fill in gaps and porous regions in the mat through which leaks could otherwise occur in sections of the membrane, which are lapped. Polymeric or elastomeric strengthening of the membrane is desired because the membrane must meet an ASTM tensile strength requirement of 25 pounds per inch. The strength of the polymer thereby allows a lighter glass mat to be used and increases product flexibility.

In the preferred embodiment, the mat is preferably generally saturated with an asphalt-based mixture comprising approximately 2% radial SBS polymer (this type of material is also referred to in the art as an elastomer); 50% filler; 24% of flux asphalt (having a melt point of approximately 100°) and approximately 24% oxidized asphalt (having a melt point of approximately 220°). The polymer additive mixed with the flux asphalt tends to make the coating much less brittle while the inclusion of approximately 50% filler in such a mixture makes the coating much less expensive given that less asphalt is required.

When using a fiberglass mat, a non-woven fiberglass weighing between one to three pounds per hundred square feet (about 0.05-0.15 kg/m.sup.2), preferably about two pounds per hundred square feet (about 0.10 kg/m.sup.2), is used. The polymeric additive composition that is applied to or incorporated within the asphalt-saturated mat can be selected from any of a wide variety of polymeric materials. For example, polyurethanes, polyethylenes, waxes, ethylene vinyl acetate (EVA), acrylic polymers and polyesters all may be used. In one preferred embodiment, the polymeric composition is a composite of an acrylic and a low molecular weight polyethylene. In another preferred embodiment, the polymer comprises a UV curable polyurethane. In still another preferred embodiment, the encapsulated mat is provided with a coating of polyethylene.

It should be noted, however, that the invention is not intended to be limited to polymeric coated embodiments. Rather, any of a wide variety of fibrous mat materials, including, but not limited to, woven and non-woven polyesters and polypropylenes, with or without polymeric additives, may be used. For example, in one preferred embodiment, the mat comprises non-woven polyester, preferably weighing between about 2.22 to about 4.88 pounds per hundred square feet, (about 0.11-0.24 kg/m.sup.2) encapsulated in the asphalt composition.

Likewise, the invention is not intended to be strictly limited to embodiments in which the fibrous mat is completely encapsulated or saturated in an asphaltic material. Rather, in one embodiment, the mat may be encapsulated within a polymeric material such as ethylene vinyl acetate (EVA) or a polyurethane. Such an encapsulated mat would still employ the adhesive asphalt layer to adhere the membrane to the roofing deck, and may optionally include a coating on its upper surface to minimize sticking when the product is rolled and when installers are walking on the product, and/or a finely ground mineral layer such as talc.

In still another embodiment, the membrane comprises a mat formed of a non-woven polymer, such as polyester that has its lower surface coated with a non-adhesive, filled asphalt with the polymer additive incorporated within. Adhesive asphalt is then coated onto the non-adhesive asphalt layer in order to provide a surface that readily adheres to the roofing deck. As above, the non-adhesive filled asphalt preferably comprises a composition of approximately 2% polymer additive; 50% filler; 24% of flux asphalt (having a melt point of approximately 100°) and approximately 24% oxidized asphalt (having a melt point of approximately 220°). This embodiment does not require an external polymeric coating or finely ground mineral coating on its upper surface, although, if desired, one or more of those may be employed.

The adhesive asphalt coating formed on one side of the mat generally comprises a material having from about 0-45% mineral stabilizer, (i.e., powdered limestone), about 0.5-15% styrene-butadiene copolymer or styrene-butadiene-styrene copolymer (radial or linear), and the balance being flux asphalt having a Ring and Ball softening point of between about 80 to 150 degree F. Additionally, tackifying oil, such as Hydrolene may be added. This second layer of material, being adhesive, is used to adhere the membrane to the roof deck.

A release sheet, as described below, can be adhered to the adhesive material to protect the adhesive properties during transport and storage of the membrane.

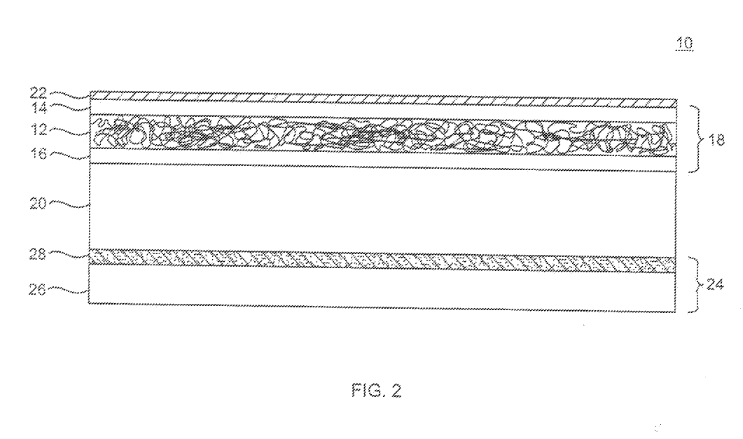

FIG. 2 depicts a roofing membrane material 10 according to one embodiment of the present invention. More particularly, as can be seen in FIG. 2, the roofing membrane material 10 comprises a multilayered structure formed of a fibrous mat 12, generally encapsulated entirely within a relatively non-adhesive asphalt composition 14, 16, to form an encapsulated mat 18, and an adhesive, rubberized asphalt layer 20 disposed on one surface of the encapsulated fibrous mat 18. A coating 22, such as acrylic, is formed on the other surface of the encapsulated mat. Talc may be applied to the coating, or granular particles may be embedded therein, to further enhance traction upon the non-adhesive surface.

Optionally, a release sheet 24, such as a paper or plastic film 26 having a siliconized surface 28 can be adhered to the relatively adhesive portion 20 of the membrane 10. The release sheet 24 is removed prior to use of the membrane material to allow the adhesive portion 20 of the membrane to be adhered to a roof surface. The release layer 24 is typically a paper sheet 26 having a siliconized surface 28. As an alternative, the release layer can comprise two separate sheets; a first supporting sheet of a paper or polymeric film, and a second sheet of a low surface energy material. Additionally, in the case of a siliconized paper, some other suitable low surface energy material such as a wax emulsion or a soap solution may replace the silicon coating.

As can also be seen in FIG. 2, the invention is characterized in that the non-adhesive asphalt 14, 16 infiltrates generally completely through the fibrous mat 12. In so doing, the non-adhesive material serves to seal the mat 12, without detracting from the mat's particular non-slip properties on its top surface. As noted previously, and especially when formed from fiberglass, a polymeric coating may be applied to the mat to further seal it and to enhance its non-slip characteristics.

The above-described structure addresses many of the needs currently embodied in the roofing industry including the novel feature of a more ductile and less costly underlayment membrane. For example, the membrane provides a good seal between the decking of the roof surface and the roofing shingles to prevent moisture from penetrating into the roof, even if ice dams are formed on the eaves of the roof. The membrane also elongates and recovers around the nails, thereby providing an excellent seal around nails that pass through the membrane to secure shingles to the decking forming the roof surface. In addition, the fibrous mat 12 serves to provide a non-slip surface to the portion of the membrane material that will be walked upon by roofing installers. This non-slip surface offers the installer greater traction, and thus, greater safety, when installing the roof, even in wet or otherwise slippery conditions. Furthermore, the non-adhesive asphalt and acrylic layers do not stick to shingles that are layered above them, thereby allowing the shingles to be removed and replaced without the need to replace underlying roof decking. Most importantly, the membrane remains less brittle in cold weather due to the addition of the copolymer and flux asphalt in the encapsulated in asphalt layers while the provision of a high ratio of filler significantly reduces the cost associated with the asphalt.

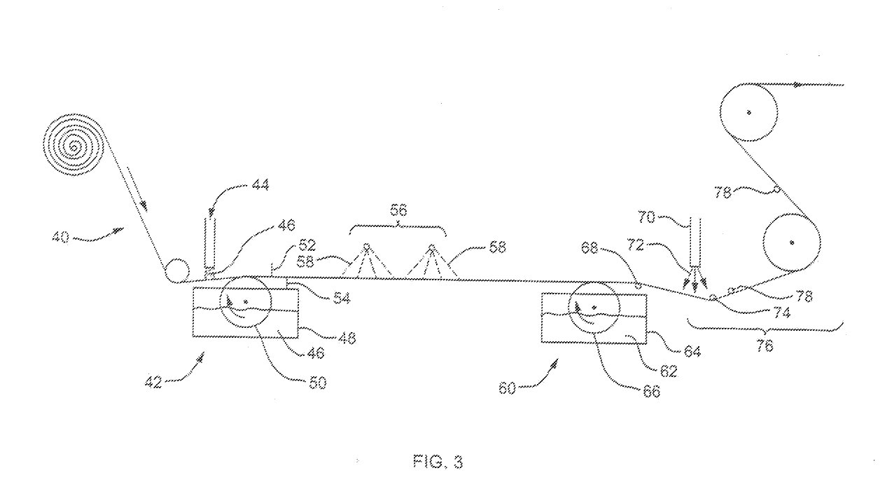

Membranes of the present invention are made using a continuous, multi-coating process. One embodiment of the process is shown in FIG. 3. As shown n FIG. 3, a web 40 of the fibrous material is passed through several coating stations. The first coating station 42 comprises an asphalt supply pipe 44 that provides an excess of the non-adhesive asphalt material 46 to the upper surface of the web. Excess non-adhesive asphalt material 46 flows over the web and into a first coating bath tank 48.

As stated above, the non-adhesive asphalt material 46 includes, in combination, oxidized asphalt, flux asphalt, filler and a radial copolymer. Because the radial copolymer will not mix well, if at all, with the oxidized asphalt, the preparation of the non-adhesive asphalt material 46 must proceed in a special manner.

First, the radial copolymer must be mixed with the flux asphalt. This step is performed in a high shear mill as is well known in the art. Typically, approximately 2% of the finished composition will be radial copolymer while approximately 24% of the finished product will be flux or non-oxidized asphalt although various blends and ratios are contemplated by the present invention. It has been found that if the oxidized asphalt is added at the same time as the radial copolymer, the radial copolymer will not disperse within the mixture.

Next, the oxidized asphalt is added in an amount comprising approximately 24% of the finished compound. Finally, a filler, such as limestone, is added in a percentage equaling approximately 50% of the finished compound. It should be noted that it is possible to add both the oxidized asphalt and the filler simultaneously to the copolymer/flux asphalt mixture. The addition of such a high percentage of filler helps to reduce the cost of the mixture while the radial copolymer provides the desired flexibility characteristics in cold weather.

Although preferred percentages of the composition as well as component content ranges have been given above, it will be apparent to someone skilled in the art, with the benefit of the present disclosure, that adding too much oxidized asphalt will make the product more brittle. It is desirable to have only enough flux or non-oxidized asphalt to be able to incorporate the polymer additive and filler content. If the percentage of non-oxidized asphalt is too high, the top surface will be sticky and will not be a walkable surface. As the amount of oxidized asphalt is raised, the amount of non-oxidized asphalt is lowered. As the amount of filler is raised, the amounts of oxidized and non-oxidized asphalt are lowered. In addition, it has been found that polymers or elastomers from different suppliers have slightly different characteristics and the amount of copolymer vis-à-vis the amount of non-oxidized asphalt will have to be adjusted accordingly. Without limiting the claims of the present invention, various exemplary and presently preferred formulas and ratios are disclosed herein, although this is not to be construed as a limitation of the present invention.

A roller applicator 50 simultaneously applies the non-adhesive asphalt material 46 to the lower surface of the web 40. The coated web is then scraped on its upper surface by an upper doctor blade 52 and on its lower surface by a lower doctor blade 54. The doctor blades serve to maintain the non-adhesive asphalt coating at a predetermined thickness.

Next, the web then passes below one or more acrylic spray heads 56, which spray an aqueous solution 58 of the acrylic coating onto the upper surface of the web. The aqueous acrylic solution is applied immediately after the web passes the first coating station 42. As such the web is still hot, due to the coating of heated asphalt, which has just been applied. The heat of the web (preferably about 175 degrees C.) causes the aqueous portion of the aqueous acrylic solution to evaporate, leaving behind the acrylic material. The heat of the web also causes the acrylic material to begin curing.

The web then passes to a second coating bath station 60. In the second coating bath station 60, heated adhesive, rubberized asphalt material 62 is contained in a second coating bath tank 64 and applied to the underside of the web 40 by a roller applicator 66. The thickness of the coating is controlled using a rolling, heated pipe positioned immediately downstream of the roller applicator 66.

As noted previously, an additional coating such as talc or granular particles may be applied to the upper surface of the membrane. This coating serves to fill gaps where the acrylic may have not fully coated the asphalt surface. In so doing, the talc prevents the membrane material from sticking to itself when rolled. If desired, for example, talc may be applied as follows. A talc supply pipe 70 provides a mixture of talc/water and/or talc/polymer mixture 72 to the upper surface of the web. This material combines with the partially cured acrylic and fills any voids that may be present in the acrylic coating. The talc mixture is metered on the web surface using a silicone-coated rubber roller 74 and one or more air blowers 78 that force excess talc mixture into a catch tray 76. The remaining talc/water mixture dries during subsequent manufacturing steps, leaving a coating of talc on the upper, acrylic surface of the web 40.

Applying talc from a water mixture is advantageous in that the water portion of the mixture is a convenient, low cost carrier for the talc, which also serves to cool the acrylic coating to prevent it from sticking to the process machinery during manufacture. It is additionally advantageous since the web must be cooled prior to the application of the release sheet (not shown) to the lower surface of the web.

The release sheet can be applied by any of a wide variety of methods known to those skilled in the art of web handling and processing. It is noted that the present invention is not intended to be limited to the particular method described above. This method has been described for illustration purposes, however, it should be understood that many other methods for forming the inventive membrane may be available to those of ordinary skill in the art.

The resulting membrane product comprises a fibrous mat encapsulated within a non-adhesive asphalt material. The encapsulated mat will have an adhesive asphalt affixed to its lower surface, and an acrylic layer affixed to its upper surface. Talc or particulate granules may optionally be deposited on or in the acrylic layer. To aid in shipping, storing and handling the membrane, a release sheet may be applied to the adhesive asphalt layer.

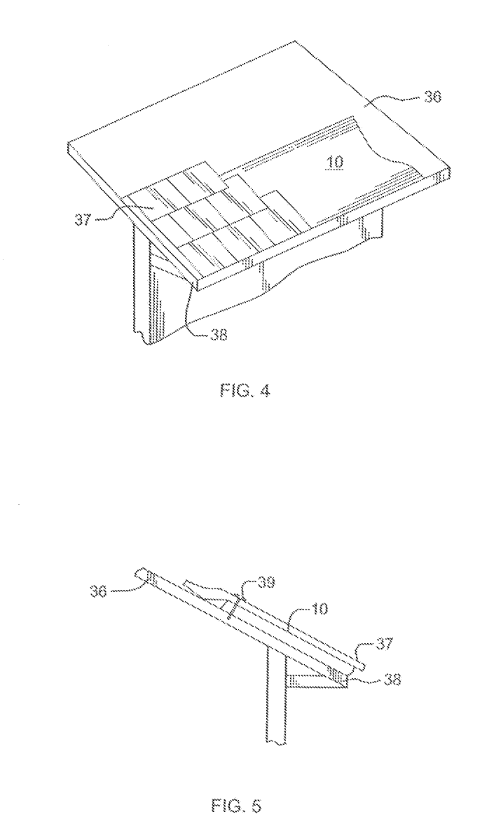

FIGS. 4 and 5 show the manner in which the membrane material 10 is intended for use on a roof deck 36 in the region, for exemplary purposes only, of the roof eaves 38. In applying the present invention, eave flashing is replaced by the membrane 10 described herein. In use, the release sheet 24 is removed from the lower surface of the double asphaltic layer 18, and the membrane 10 is secured to the roof deck 36 by adhesive action. The membrane 10 is positioned along the leading edge of the roof. Subsequently, a first row of shingles 37 is positioned in an overlying relationship to the membrane 10. The shingles are secured in place using nails 39. Although the roofing installer will often be caused to stand on the membrane during installation of the shingles, the fibrous mat of the inventive membrane 10 provides sufficient friction to minimize the likelihood of slipping. Thus, as compared to many of the known roofing membranes, the membranes of the present invention provide a safer work surface.

In another embodiment of the present invention, a linear low-density polyethylene (LLDPE) is melted with a polyethylene wax. The combination achieves a high-tear strength and kills the stickyness of the flux. The combination doubles the tear resistance. LLDPE increases the melting point to a range of 250-400 degrees F. (about 121-205 degrees C.). The polyethylene wax raises the softening point and reduces the viscosity when at a high temperature and also hardens and cools to a high melting point. The polyethylene wax has a low molecular weight that is compatible with asphalt. The wax has a thermal range that does not exceed the asphalt melting point and therefore does not break down the asphalt at the wax processing temperature.

As mentioned above, the present invention is not intended to be limited to a system or method which must satisfy one or more of any stated or implied object or feature of the invention and should not be limited to the preferred, exemplary, or primary embodiment(s) described herein. Modifications and substitutions by one of ordinary skill in the art are considered to be within the scope of the present invention, which is not to be limited except by the allowed claims and their equivalents.

The invention claimed is:

1. A roofing membrane material comprising:
a) fibrous mat having an upper surface and a lower surface;
b) a non-adhesive asphalt coating applied to said fibrous mat and generally completely saturating said fibrous mat and providing a layer of non-adhesive asphalt at least on said upper surface of said fibrous mat, said non-adhesive asphalt coating comprising an oxidized asphalt, a non-oxidized asphalt, a polyolefin melted with a polyethylene wax, and a filler material; and
c) an adhesive asphalt coating, applied to the lower surface of the non-adhesive asphalt saturated mat.

2. The roofing membrane material of claim 1 wherein said polyolefin is a linear low-density polyethylene.

3. The roofing membrane material of claim 1 wherein said non-adhesive asphalt coating includes approximately 0.5% to 3% asphalt additive, 10% to 60% filler, 10% to 40% non-oxidized asphalt and 10% to 40% to oxidized asphalt.

4. The roofing membrane material of claim 1 wherein said non-adhesive asphalt coating includes approximately 2% asphalt additive, 24% oxidized asphalt, 24% non-oxidized asphalt and 50% filler.

5. The roofing membrane material of claim 1 wherein the fibrous mat comprises a non-woven fibrous mat.

6. The roofing membrane material of claim 1 wherein the fibrous mat comprises fibers selected from the group consisting of polyesters, polypropylenes and fiberglass.

7. The roofing membrane material of claim 1 wherein the encapsulated fibrous mat further includes a polymeric coating or polymer additive within the non-adhesive asphalt composition on at least a portion of the upper surface of the mat.

8. The roofing membrane material of claim 6 wherein the polymeric coating is provided with a coating of a finely-ground mineral.

9. The roofing membrane material of claim 6 wherein the finely-ground mineral comprises talc.

10. The roofing membrane material of claim 6 wherein the polymeric coating, or polymer incorporation is selected from the group consisting of ethylene vinyl acetate, polyurethanes, polyethylenes, waxes, acrylic polymers and polyesters.

11. The roofing membrane material of claim 1 which further including a release sheet adhered to the adhesive asphalt coating.

12. The roofing membrane material of claim 1 wherein the filler material comprises limestone filler.

13. The roofing membrane material of claim 1 wherein the adhesive asphalt coating comprises, in combination:
a) flux asphalt;
b) a filler material;
c) a material selected from the group consisting of styrene-butadiene copolymers and styrene-butadiene-styrene copolymers; and
d) a tackifying oil.

14. The roofing membrane material of claim 13 wherein the filler material comprises limestone filler.

15. A roofing membrane material which comprises in combination:
a) a fibrous mat having an upper surface and a lower surface;
b) a non-adhesive asphalt coating applied to and generally completely saturating said fibrous mat, said non-adhesive asphalt coating comprising approximately 0.5% to 3% polyolefin, 10% to 60% filler, 10% to 40% non-oxidized asphalt and 10% to 40% to oxidized asphalt, and wherein said polyolefin is a radial copolymer selected from the group consisting of styrene-butadiene copolymers and styrene-butadiene-styrene copolymers; and
c) an adhesive asphalt coating applied to the lower surface of the asphalt saturated fibrous mat.

16. The roofing membrane of claim 15 wherein the non-adhesive polymeric additive is selected from the group consisting of ethylene vinyl acetate and polyurethane.

17. The roofing membrane material of claim 15 wherein the adhesive asphalt coating comprises, in combination:
a) a flux asphalt;
b) a filler material;
c) a material selected from the group consisting of styrene-butadiene copolymers and styrene-butadiene-styrene copolymers; and
d) a tackifying oil.

18. A roofing membrane material that comprises in combination:
a) a fibrous mat having an upper surface and a lower surface;
b) a non-adhesive asphalt coating applied to and generally completely saturating at least one surface of said fibrous mat, said non-adhesive asphalt coating comprising approximately 20% to 95% of oxidized and/or non-oxidized asphalt, 0.5% to 30% thermoplastic polymer, 0.5% to 30% organic filler, 0% to 20% process oil and 5% to 60% inorganic filler material; and
c) an adhesive asphalt coating applied to the lower surface of the asphalt saturated fibrous mat.

19. The roofing membrane of claim 18 wherein the organic filler is an asphalt compatible oil, such as an aromatic or paraffinic hydrocarbon oil.

20. The roofing membrane of claim 18, wherein the organic filler is selected from the group consisting of a polymer with a melting point about 500 degrees Fahrenheit, a cross-linked polymer or a thermoset polymer.
